(19) United States
(12) Patent Application Publication
(10) Pub. No.: US 2012/0023944 A1
(43) Pub. Date: Feb. 2, 2012

(54) DEVICE FOR PHASE SEPARATION OF A MULTIPHASE FLUID FLOW, STEAM TURBINE PLANT HAVING SUCH A DEVICE, AND ASSOCIATED OPERATING METHOD

(75) Inventor: Barnaby Bruce, Erlangen (DE)

(73) Assignee: AREVA NP GMBH, ERLANGEN (DE)

(21) Appl. No.: 13/262,713

(22) PCT Filed: Mar. 8, 2010
(86) PCT No.: PCT/EP10/01436

§ 371 Date: Oct. 14, 2011

(30) Foreign Application Priority Data
Apr. 1, 2009 (DE) 10 2009 015 260.1

(51) Int. Cl. F01K 13/00; B01D 45/16

(52) U.S. Cl. 60/645; 55/434.2; 60/676

(57) ABSTRACT

A device for phase separating a multi-phase fluid flow has a housing configured substantially rotationally symmetrically about a center axis and encloses a hollow space, at least one in-feed line for the fluid flow configured for inflow of the fluid flow directed substantially tangentially to an interior of the housing, and at least one outlet line for the separated gaseous portion of the fluid flow. The device heats the gaseous portion of the fluid flow, such as steam, and requires little material and space. To this end, heating elements configured for heating the gaseous portion are disposed in the hollow space in an annular chamber placed concentrically about the center axis.

The invention relates to a device for phase separation of a multiphase fluid flow, with a housing which is essentially rotationally symmetrically designed around a center axis and encloses a cavity, with at least one feed line for the fluid flow which is designed for an inflow of the fluid flow which is oriented essentially tangentially to the inner side of the housing, and with at least one discharge line for the separated gaseous fraction of the fluid flow. The invention furthermore relates to a steam turbine plant with a high-pressure turbine and a low-pressure turbine and with such a device. It also relates to a method for operating such a steam turbine plant.

In power plants, especially nuclear power plants, in which steam is used for energy generation or energy conversion, different turbines, which operate at different steam pressure, are customarily used. The live steam which is produced in a power plant is directed in this case into a high-pressure turbine, for example, performs work there, and is therefore expanded. Before the steam is now introduced into a low-pressure turbine which is designed for lower steam pressure, its water content is customarily reduced. Furthermore, superheating of the steam is usually provided before its introduction into the low-pressure turbine. As a result of these measures, on the one hand the efficiency of the low-pressure turbine is increased, and on the other hand the service life of the turbine is increased since damage, which can arise as a result of droplet-induced erosion or corrosion of the components, for example, is reduced or avoided.

In order to thus process the expanded steam which issues from the high-pressure turbine, water separators and repeaters, which are connected in series according to flow, are customarily used and can be constructionally combined with each other in the style of a side-by-side mounting or tandem mounting (combined water separator/reheater, WSRH for short). In this case, in a first component of the water separator/reheater the water fraction of the steam is customarily reduced before the now essentially gaseous fraction is guided into a second component in which it is superheated. The therefore superheated steam is now introduced into the low-pressure turbine where it is expanded and performs work as a result.

For separating the water fraction, different devices can be used. Counted among these are plates, for example, on which the steam flow is guided along. For separating the water fraction, use can also be additionally made of a so-called cyclone separator or cyclone, in the essentially rotationally symmetrical housing of which the steam flow is introduced tangentially to the inner side of the housing. As a result, the heavier water fraction is forced outwards by means of centrifugal force, and the lighter, essentially gaseous fraction, on account of the flow conditions which are formed in the cyclone, flows into the interior of the cavity, which is enclosed by the housing, and accumulates there. In both cases, the gaseous fraction of the steam is now directed into a second component of the WSRH, which is connected downstream according to flow and constructionally/spatially separated, and in which it is superheated. This is usually achieved by heating tubes being exposed to inflow by the steam, which heating tubes correspondingly heat or superheat the steam by means of heat transfer.

So that the separation of water or the reheating of the steam can be carried out satisfactorily, the respective components must correspondingly be of volumetrically large dimensions, from which a corresponding material cost and areal space requirement directly ensues. On the other hand, material requirement and space requirement which are as low as possible are desirable in the construction of power plants.

The invention is therefore based on the object of providing a device for phase separation of a multiphase fluid flow, which is suitable for heating the gaseous fraction of the fluid flow, for example steam, and makes low demands upon material and space requirement. Furthermore, a steam turbine power plant with a high-pressure turbine and a low-pressure turbine and in which such a device can be especially advantageously used, is to be disclosed. In addition, a method for operating such a steam turbine plant is to be disclosed.

With regard to the device for phase separation of a multiphase fluid flow, this object is achieved according to the invention by heating elements, which are designed for heating the gaseous fraction, being arranged in the cavity in an annulus which is located concentrically around the center axis.

Advantageous developments of the invention are the subject of the dependent claims.

The invention is based on the consideration that the comparatively large space requirement of conventional water separators/reheaters is based inter alia upon the fact that the separation of water from the steam which originally issues from the high-pressure turbine and the subsequent superheating of the separated gaseous fraction are carried out in respect to time one after the other in two spatial regions or device components which are spatially separated from each other and which are arranged one behind the other in the style of a flow-side series connection. As a result, specific demands are made upon the constructional design of the water separators/reheaters which for system-related reasons require a relatively large installation space.

As has now been recognized, however, these two spatial regions do not necessarily have to be constructionally arranged in series in separate housings. Subject to suitable flow conditions, these spatial regions can particularly also be arranged in a manner in which they are nested one inside the other in a single housing, wherein the fluid separation and the superheating of the gaseous fluid fraction for a given volume element of the fluid are carried out essentially simultaneously or in quick succession, as seen in respect to time.

Such suitable flow conditions are provided by a water separator in the constructional style of a cyclone. As a result of the exposure of the inner side of the housing of the cyclone to the tangential inflow, the separating of the heavy component, for example water, as a result of the centrifugal force acting upon the flow, is carried out on the inner side of the housing in the outer region of the cavity which is enclosed by the housing. The lighter, gaseous fraction of the original fluid flow, for example steam, flows into the interior of the cavity in the process. If in an inner or middle region of the cavity, especially in an annulus, heating elements for heating or superheating the gaseous fraction are now arranged in such a way that the transfer of the lighter phase into the inner region is furthermore enabled, then the gaseous fractions are heated or superheated directly during their transfer into the inner region. As a result, an inner spatial region, which essentially contains the superheated steam, is created inside the outer spatial region, which is designed for water separation. The superheated, gaseous fraction can then be extracted from the inner spatial region and reused according to requirement. As a result of this nesting one inside the other of the two functionally different spatial regions, a combined water separator/repeater can be realized in a distinctly compact type of construction. In addition to this, savings can be made on material costs since only a single housing is required for the two processes.

Such a construction is not limited to the treatment of steam. It can always be used when one or a plurality of phases of heavy particles or constituents are to be separated from a multi-component fluid flow and the light fraction(s) of the original fluid flow is, or are, to be heated.

In one preferred embodiment, the annulus with the heating elements is designed for a throughflow of the gaseous fraction of the fluid flow. In this case, it separates the cavity into an inflow chamber, which lies between the inner side of the housing and the annulus, and into an outflow chamber which lies inside the annulus. A clear separation of the two spatial regions allows a separation of the two consecutive processes in an optimum manner. It is particularly advantageous if the fraction of the fluid flow which enters the inflow chamber has a fraction of the heavy component which is as small as possible in order to save on energy for its heating. When used in a steam turbine plant, efficiency and service life or maintenance intervals of the turbine can be increased as a result.

Depending upon the composition of the multi-component fluid flow, different configurations of the rotationally symmetrical housing are advantageous. For example, the housing can taper in its cross section in one direction, especially in the direction towards the discharge line (flow outlet). Separation of water from a steam/water flow is preferably carried out in an essentially hollow-cylindrically designed housing.

In order to utilize gravity force for the separation of the heavy component of the multiphase fluid flow in an optimum manner, the center axis of the housing preferably has an essentially vertical orientation. The heavy component of the fluid flow then moves (flows) downwards on the inner side of the housing and can be collected or discharged there. In general, a vertical mounting of the cyclone separator is advantageous since in this case the gravity force induces no imbalance in the vortical flow.

For using the device in a steam turbine plant with a high-pressure turbine and low-pressure turbine, the steam extracted from the high-pressure turbine should be fed to the low-pressure turbine in the superheated state. To this end, the heating elements, with regard to their heating capacity, should be designed for superheating the gaseous fraction of the fluid flow, especially steam.

A use of the device which is as effective as possible is achieved if the multiphase fluid flow is fed through a plurality of feed lines. If the feed lines—in any event in the region of their housing connection—lie in a plane which is essentially perpendicular to the center axis of the housing, they are advantageously designed in such a way that the velocity vector of the fluid flow which enters the cavity has a component which points out of this plane. An averaged velocity vector which is averaged over the individual constituents of the fluid flow is meant in this case. As a result, intercollision of the fluid flows which enter through the various feed lines can be prevented, and the fluid flows maintain a preferred orientation in the direction of the center axis. In this case, the fluid flow advantageously flows in at an angle of between 10° and 30°, especially of about 15°, to a plane which is perpendicular to the center axis. That is to say, a velocity component in the direction of the center axis is preferably superimposed upon the vortical flow which ensues as a result of the wall geometry, so that overall a helical flow is formed. In the case of a vertical mounting of the separating device, the velocity component which is oriented in the direction of the center axis advantageously points downwards.

Four feed lines, which are arranged with a uniform and symmetrical distribution over the circumference of the housing, are preferably used for the inflow of the fluid flow. With suitable dimensioning of the housing, the inflowing fluid flow can advantageously be split into four equally sized regions of the inner side of the housing in this way without the individual flows colliding and being disturbed in the process.

The flow conditions which are formed in the housing of the device ensure that the gaseous fraction of the fluid flow flows into the interior of the cavity which is enclosed by the housing. It flows onto the heating elements there and is heated or superheated in the process. The direction with which the heating elements are exposed to inflow can be optimized by means of baffle plates or guide vanes which are arranged in the inflow chamber. For example, in this way the effect can be achieved of the heating tubes being essentially frontally exposed to inflow or of the tangential component being able to be reduced. Since, on the other hand, these guiding elements make the inflow chamber smaller, it should be decided, depending upon application, whether, and with which dimensions, they are used.

If necessary, if the degree of separation achieved as a result of the cyclonic action is too poor and the gaseous fraction of the fluid flow, which transfers into the inner region, entrains an amount of the heavier liquid component which is too great for the intended application or for the further heating, fine separators can be arranged in the inflow chamber for further separation. The condensate which forms in the fine separator can be discharged from the cavity through a condensate drain line.

The device is suitable both for single-stage and for multistage (double) superheating. For two-stage or multistage superheating, for example two groups or a plurality of groups of heating elements can be arranged in series in the annulus, as seen in the direction of the center axis. The heating elements which are associated with the individual groups can be designed in this case for different heating capacities or heating temperatures in each case.

In one preferred embodiment of the device, the heating elements are of a tubular design. For heating or superheating the gaseous fraction, the heating elements can be subjected to throughflow by a fluid heating medium, especially steam. For multistage heating, for example steam at different pressure and/or different temperature can be used in different groups of heating elements for this purpose.

For a heating of the gaseous fraction which is as effective as possible, rectilinear tubes, which are oriented parallel to the center axis of the building, are used as heating elements. For this, a multiplicity of tubes, which, depending upon application, can be differently designed, can be arranged in the annulus. For example, smooth tubes or finned tubes, or favorable combinations of these tube types, can be used. The individual tubes are expediently spaced apart in such a way that as a result of the remaining gaps a transfer which is as unhindered as possible of the gaseous phase, which is separated from the fluid flow, from the outer inflow chamber into the inner outflow chamber can be carried out. On the other hand, a certain “density” of tubes is naturally required in order to realize the intended heating effect.

The heating tubes are advantageously combined to form tube bundles. In this case, use can be made of so-called annular bundles, in which the tubes are arranged in the annulus with a distribution which to a greater or lesser extent is uniform. Alternatively to or in combination with this, so-called individual bundles can be used. In this case, a plurality of heating elements, which are adjacent to each other, are combined in each case to form a bundle. The individual bundles can be preassembled and can be handled as a whole. If necessary, they can be installed, removed or exchanged more easily than individual tubes.

In one preferred embodiment, an annular partitioning plate, which is oriented perpendicularly to the center axis, is inserted into the housing, which partitioning plate splits the cavity into two cavity sections, and the inner circle of which coincides essentially with the inner circle of the annulus, and the outer circle radius of which is slightly smaller than the radius of the inner side of the housing. As a result, the two cavity sections are interconnected according to flow only by means of a passage which lies in the inner circle of the partitioning plate and therefore inside the annulus. The feed lines and the discharge lines are advantageously located in different cavity sections in each case. The gaseous fraction of the fluid flow can be especially favorably guided through the housing in this way, wherein it is ensured that it flows through the annulus twice, specifically once from the outside inwards and once from the inside outwards. Since the partitioning plate does not reach as far as the inner side of the housing in the radial direction, the condensate can flow out without hindrance there.

With regard to the steam turbine plant, the aforesaid object is achieved according to the invention by the feed line, or all the feed lines, of the separating device described above being connected to the steam outlet of the high-pressure turbine, and by the discharge line, or all the discharge lines, being connected to the steam inlet of the low-pressure turbine. Therefore, the steam from the high-pressure turbine is introduced into the separating device in which, on the one hand, the water fraction is separated from the steam and, on the other hand, the gaseous fraction is superheated. The superheated steam is then introduced into the low-pressure turbine where it is used for further energy generation.

With regard to the method, the aforesaid object is achieved according to the invention by the steam which is extracted from the steam outlet of the high-pressure turbine being directed into a cavity which is enclosed by a housing which is essentially rotationally symmetrical around a center axis, as a result of which the steam is set in rotation and its gaseous fraction is separated from the liquid fraction and collected in an inner region of the cavity which is enclosed by the housing, and wherein the gaseous fraction during its transfer into the inner region is heated by means of heating elements and is then fed to the steam inlet of the low-pressure turbine.

In a preferred version of the method, at least some of the heating elements are of a tubular design, therefore form heating tubes. The live steam which is produced by the steam generator is directed into at least some of the heating tubes, as a result of which the gaseous fraction—in contact with the outer sides of the heating tubes—of the fluid flow which is introduced into the separating device, is heated or superheated. Alternatively to or in combination with this, bleed steam can be extracted from the high-pressure turbine and then directed into at least some of the heating elements. In this way, especially a two-stage or multistage superheating of the gaseous fraction of the fluid flow can be achieved.

The advantages which are achieved using the invention are especially that as a result of a clever arrangement of heating elements inside a cyclone separator, a separation of a heavy component or of a liquid phase of a multiphase fluid flow with simultaneous heating or superheating of the gaseous fraction of the fluid flow can be realized in a decidedly space-saving and material-sparing and constructional cost-sparing way. As a result, the device is especially suitable for use in plants which have to be built in a confined space. For primary separation of the heavy component or phase of the fluid flow, the cyclone principle is utilized in this case.

The installation of additional fine separators allows a further reduction of the heavy component. The exposure of the heating elements—which are designed for heating or superheating the light phase of the fluid flow—to inflow can be further improved by using baffle plates, guide vanes or perforated plates.

A steam turbine plant, in which such a separating device is connected between a high-pressure turbine and a low-pressure turbine, can be realized in a particularly compact and material-sparing way. In this case, the device can essentially be attached in a vertically mounted housing directly beneath the high-pressure turbine so that the gas from the steam outlet of the high-pressure turbine at the upper end of the housing can flow into the device. By means of discharge lines at the lower end of the housing, the superheated steam can then be fed to the low-pressure turbine.

Different exemplary embodiments of the invention are subsequently explained with reference to a drawing. In the drawing, in a greatly schematized representation:

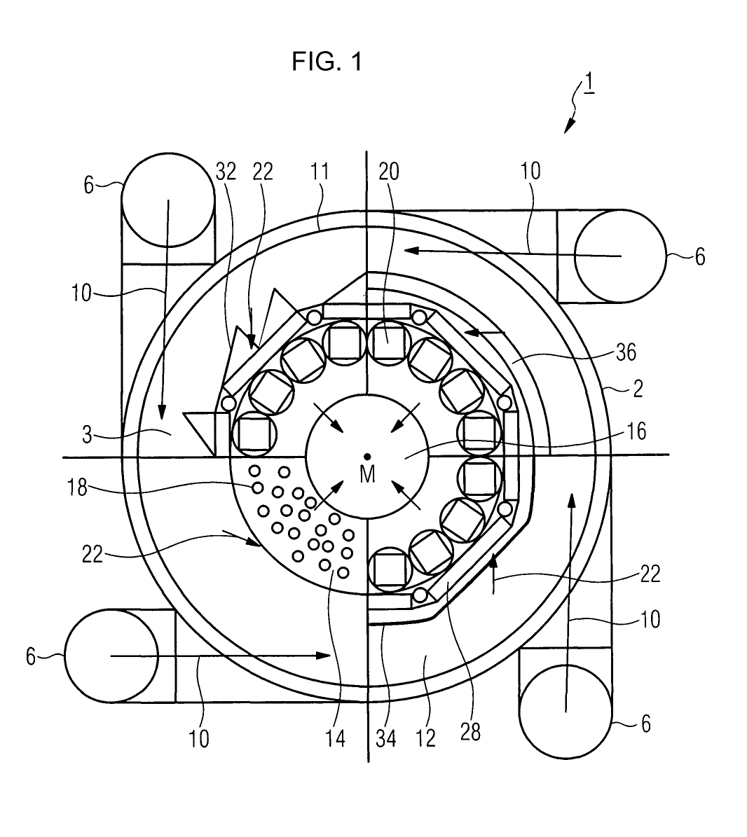

FIG. 1 shows four different quarter-circle-shaped partial cross sections, placed against each other, of four different possible configurations of a device for phase separation of a multiphase fluid flow, with a housing which is designed essentially rotationally symmetrically around a center axis, wherein the respective cross-sectional plane is selected perpendicularly to the center axis,

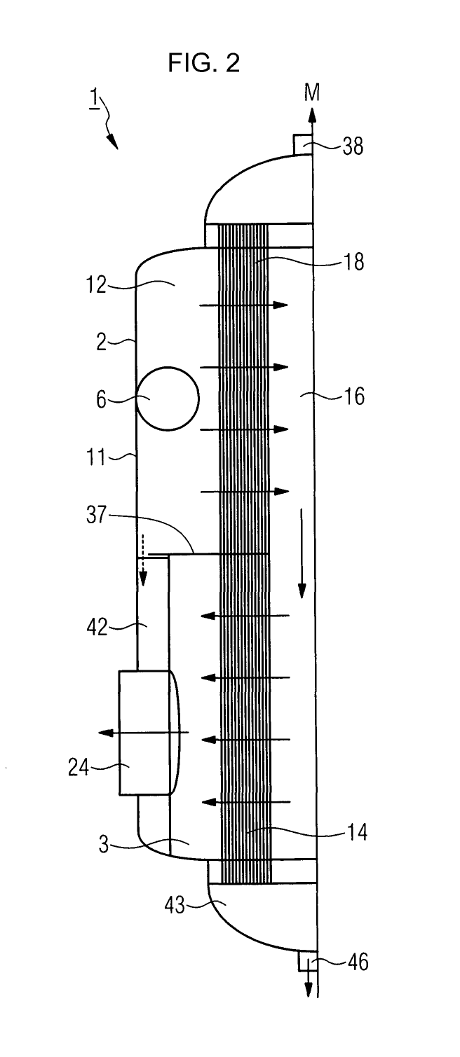

FIG. 2 shows a longitudinal section through the left-hand-side half of an embodiment of the device according to FIG. 1,

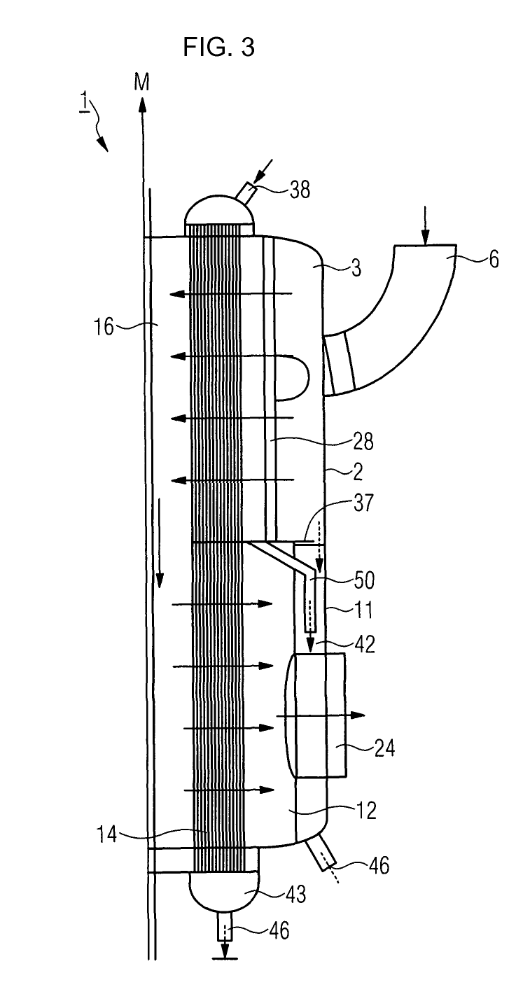

FIG. 3 shows a further embodiment of the device according to FIG. 1 in right-hand-side longitudinal section,

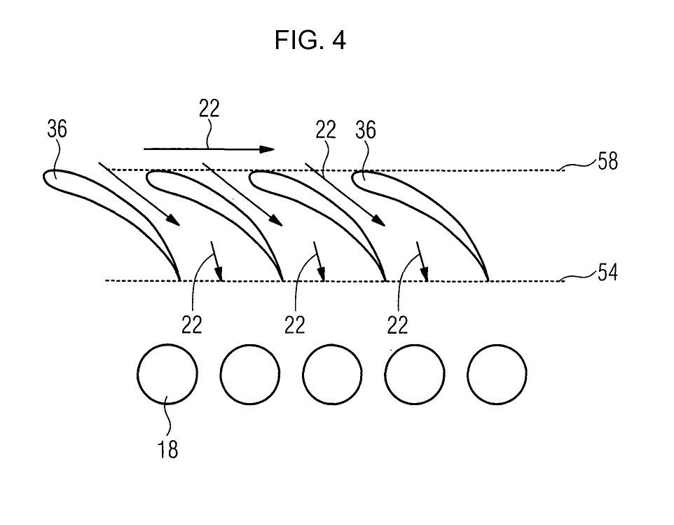

FIG. 4 shows a multiplicity of heating elements of the device according to FIG. 1 to FIG. 3 and of guide vanes associated with the heating elements, in this case shown in cross section with direction of view towards the center axis,

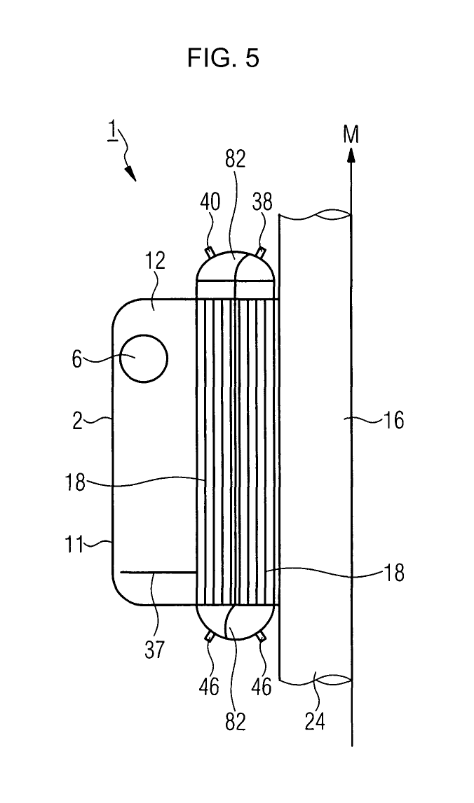

FIG. 5 shows a longitudinal section through the left-hand-side half of a further preferred embodiment of the device according to FIG. 1, and

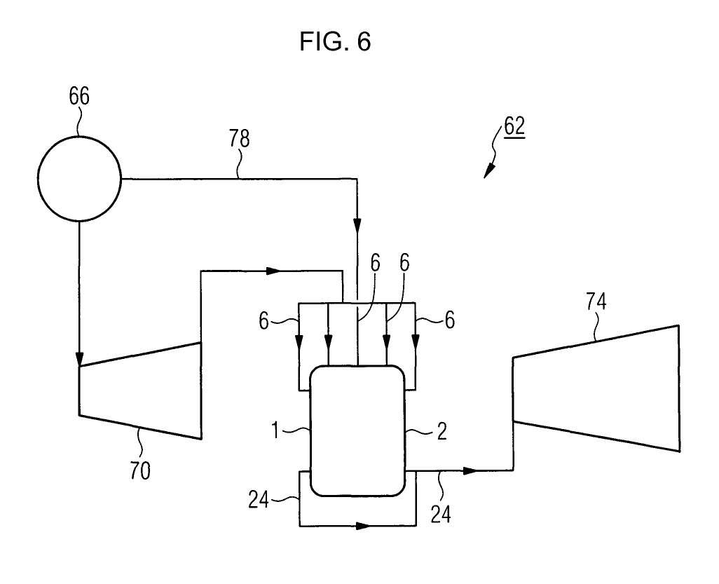

FIG. 6 shows a schematized block diagram of a steam turbine plant with a high-pressure turbine, a low-pressure turbine, a live-steam generator and with a device for phase separation of a multiphase fluid flow according to an embodiment according to FIG. 1 to FIG. 5.

Like parts are provided with the same designations in all the figures.

The device 1 which is shown in FIG. 1 for phase separation of a multiphase fluid flow comprises a housing 2 which is designed essentially hollow-cylindrically and rotationally symmetrically around a center axis M, which housing encloses a cavity 3, and into said housing four feed lines 6 are let in. In this case, each quadrant of FIG. 1 corresponds to a possible configuration of the device, wherein in actual fact all four quadrants are realized in each case in one of the four ways which are shown here. The housing 2, in a preferred development, has a diameter of about 6 meters.

The multiphase fluid flow (not drawn in) in this case flows into the cavity 3, which is enclosed by the housing 2, in an inflow direction 10 essentially tangentially to the inner side 11 of the housing. The fluid flow can be steam, for example, which is directed from the steam outlet of a high-pressure turbine, which is installed in a steam turbine plant, through the feed lines 6 into the housing 2 of the device 1. The housing 2 is preferably produced from steel or stainless steel, wherein other materials can also be advantageous, depending upon the field of application.

The fluid flow in this case is set in rotation, wherein the centrifugal force which acts upon the fluid flow draws the heavy component of the fluid flow, in this case water, downwards onto the inner side 11 of the housing. The gaseous fraction of the fluid flow, on account of the flow conditions which are formed within the cavity 3, moves from the inflow chamber 12 into the annulus 14. The ring-like annulus 14 spatially includes the cylindrical outflow chamber 16 which lies inside the housing 2. Arranged in the annulus 14 are heating elements which, in respect to their heating capacity, are designed for superheating the gaseous fraction of the fluid flow. Individual heating tubes 18, which in their entirety virtually form annular bundles, can be used in this case. With a length of the tubes used in the annular bundle of about 13 m and a housing diameter of 6 m, a heating surface of about 16,000 m² is made available in the case of a total number of about 5000 tubes with an outside diameter of the bundle of about 3.5 m and a tube diameter of about 2.3 cm in each case. Alternatively to this, or in combination with the heating tubes 18, individual bundles 20 can be used. The heating tubes 18 or individual bundles 20 are exposed to inflow in the flow direction 22 by the gaseous fraction of the fluid flow. The gaseous fraction is superheated in the annulus 14, whereupon it further flows into the outflow chamber 16. From there, it is transferred through discharge lines 24 (not drawn in in FIG. 1) into the low-pressure turbine.

With a direct exposure of the heating elements to inflow by the fluid flow, a separation efficiency of the water of up to about 80% can be achieved on the basis of earlier experiences. This means that the steam flowing onto the heating tubes 18 or individual bundles 20 still has about 2.6% water fraction. In order to reduce the water fraction still further when necessary, fine separators 28 can be attached in the inflow chamber 12. As fine separators 28, differently configured plates, for example, can be used. So-called finned separators can also be used. A further alternative consists of packets of corrugated plates. These separating elements are customarily fastened or anchored in a frame. With the aid of the fine separators 28, the water fraction can be reduced to about 0.5% to 1%. However, a pressure loss accompanies the introduction of the fine separators 28 into the inflow chamber 12 and the inflow chamber 12 is made smaller. In the exemplary embodiment, the fine separators 28 are arranged on an outer circle of about 4 m diameter which is located around the center axis M and provide an onflow surface of about 70 m².

In consideration of the overall energy balance of the device 1, the additionally consumed heat, which was created as a result of the increased water fraction of about 2.6% (without fine separators 28) in comparison to 0.5% to 1% (with fine separators 28) at the inlet of the tube bundle, is likely to be negligible as a result of the omission of the pressure loss created as a result of the fine separators 28. The energy balance in this case is created as follows: In order to arrive at the same discharge pressure and same discharge temperature of the steam at the discharge line 24 in the case of a water fraction of 2.6% as in the case of a water fraction of 0.5% to 1%, about 20% more live steam has to be tapped from the live-steam line or from the high-pressure turbine and introduced into the heating tubes. If, however, the tube-side mass flow through the heating tubes remains the same, the discharge temperature drops by about 20 K on account of the approximately 2% higher water content. Per Kelvin temperature loss, the generator power in a typical power plant turbine drops by about 0.2 MWₑ (megawatt electrical). On the other hand, 10 MWₑ of generator power is gained per bar less pressure loss. A discharge temperature loss of the superheated steam of about 20 K can therefore be compensated by a reduction of the discharge pressure loss of about 400 mbar.

In order to improve the exposure of the heating elements to inflow or in order reduce or completely eliminate the tangential component of the inflow velocity, baffle plates 32, perforated plates 34 or guide vanes 36 can be arranged in the inflow chamber 12. As a result of these deflection devices, however, the inflow chamber 12 is reduced in its size. Baffle plates 32, perforated plates 34 and guide vanes 36 can be used in the device 1 alone or in different combinations with each other in each case.

Tube bundles, as are used inter alia in heat exchangers, can be used as heating elements. In order to provide a heating surface which is as large as possible, finned tubes or slotted finned tubes can be used in this case. Smooth tubes—if necessary in combination with these—can also be used. The tubes in this case for example are exposed to throughflow by live steam at about 70 bar and/or—in the case of multistage heating—by bleed steam from the high-pressure turbine at about 30 bar. The heating tubes 18 preferably have a round cross-sectional profile on the outer side so that as little flow resistance as possible opposes the fluid flow which is to be heated.

The device 1 is shown in a possible embodiment in FIG. 2 in a left-hand-side longitudinal section. In this embodiment, the housing 2 of the device 1 is mounted essentially vertically. The housing 2 is essentially of a hollow-cylindrical design and rotationally symmetrical around the center axis M. Heating tubes 18, in the form of an annular bundle, are mounted in the annulus 14. For superheating the gaseous fraction, live steam is fed to the heating tubes 18 through the live-steam line 38. About halfway along the height of the housing 2, the cavity 3 is split into an upper and a lower cavity section by means of a horizontally oriented, annular partitioning plate 37. The partitioning plate 37 extends in the radial direction from the inside diameter of the annulus 14 or annular bundle almost up to the inner side 11 of the housing. In this way, the upper and the lower cavity sections are connected according to flow only via the connecting section of the outflow chamber 16 lying inside the partitioning plate 37. This construction can be combined (in any case in the upper cavity section) with all four variants which are shown in FIG. 1.

The heating tubes 18 can be guided through the partitioning plate 37 and extend across both cavity sections. Alternatively to this—especially in the case of two-stage heating—two groups of heating tubes 18, specifically one group in the upper cavity section and one group in the lower cavity section, can be used. In this case, the heating tubes 18 of the two groups can be designed for different heating capacities in each case.

The steam which issues from the high-pressure turbine is directed through the feed lines 6 into the housing 2 into the upper cavity section and flows onto the inner side 11 of the housing in a tangential direction. During this, the water fraction of the steam is separated on the inner side 11 of the housing. On account of the flow conditions which are formed in the cyclone, and, if applicable, by means of baffle plates 32, guide vanes 36 or perforated plates 34, the gaseous fraction of the steam flows into the outflow chamber 16 and crosses the transition located inside the partitioning plate 37 to the lower cavity section. The gaseous fraction, after passing through the transition, changes its direction and is again directed outwards through the annulus 14 in the direction of the inner side 11 of the housing, wherein reheating is carried out by means of the heating tubes 18 which are arranged in the annulus 14. The heated gaseous fraction then flows into the discharge lines 24 attached on the side of the housing 2 and continues into the low-pressure turbine.

Since the partitioning plate 37 does not fully reach the inner side 11 of the housing, but an annular gap remains there, the condensate, in this case water, flowing down on the inner side 11 of the housing, can enter the condensate drain 42 in the lower cavity section. Furthermore, provision is made in the deepened bottom region of the housing 2 for a second condensate drain 43 via which the condensate which collects in the lower cavity section can drain away through a condensate drain line 46.

A further development of the device 1, which can be combined with the previously shown embodiments, is to be seen in FIG. 3. In this case also, the center axis M of the housing 2 is essentially vertically oriented. The feed lines 6 open into the housing 2 in such a way that the fluid flow flows onto the inner side of the housing 2 with a gradient of about 15°. As a result, a downwards directed velocity component, exceeding the gravity force action, is superimposed upon the vortical flow inside the cavity, as a result of which the desired, essentially spiral or helical flow guiding is promoted.

Furthermore, in the variant shown in FIG. 3, fine separators 28 are attached in the inflow chamber 12 for enhanced separation of water. The condensate which collects in the fine separators 28 is directed by means of a fine-separator condensate drain line 50 into the condensate drain 42. The condensate, in this case water, is directed out of the housing through the condensate drain lines 46.

A possible embodiment of the optionally provided guide vanes 36 is shown in a cross section in FIG. 4. The selected cross-sectional plane lies perpendicularly to the center axis M of the device 1. In this case, the guide vanes 36 are mounted between an imaginary inner boundary 54 and an outer boundary 58. The boundaries 54 and 58 are actually circular, which is not apparent, however, in FIG. 4 which is entirely schematic and not true to scale. The guide vanes 36 in this case have a curved profile which tapers in the direction of the heating tubes 18 (only the outer heating tubes 18 of the annular bundle which is encompassed by the guide vanes 36 are shown). The guide vanes 36 influence the flow direction 22 of the fluid flow. By a suitable shape and positioning of the guide vanes 36, the effect can be achieved of the heating tubes 18 being essentially frontally exposed to onflow. A tangential or oblique exposure of the heating tubes 18 to onflow can be greatly reduced or avoided as a result.

The embodiment of the device 1 which is shown in FIG. 5, with essentially vertical orientation of the center axis M, is designed for a two-stage heating or superheating of the fluid flow. To this end, a group of heating tubes 18, which is located in the outer region of the annulus 14, is supplied, via a bleed-steam line 40, with the bleed steam, at about 30 bar, which is extracted from a high-pressure turbine, for example. Live steam at about 70 bar is fed to an inner group of heating tubes 18 via the live-steam feed line 38. The condensate which forms in the annulus 14 can be drained from the device 1 via the condensate drain lines 46. Between the inlet headers for the groups of heating tubes 18, which are supplied with different steam, partitioning plates 82 can be provided for division of the respective steam supplies. This also applies to the outlet headers.

From the fluid flow which enters the housing 2 through the feed line 6, the water fraction is separated on the inner side 11 of the housing and, if applicable, additionally separated on fine separators 28 which are arranged in the inflow chamber 12, whereas the gaseous fraction flows into the annulus 14. In the process, the gaseous fraction first flows around the outer group of heating tubes 18, which is supplied with bleed steam, and after that, on its path into the interior of the outflow chamber 16, flows onto the inner group of heating tubes 18. The gaseous fraction is thus successively heated on its path into the interior of the outflow chamber 16. This type of two-stage heating can obviously be generalized to a multistage heating by means of additional steam feed lines and tube groups. In addition, this form of two-stage or multistage heating can be combined with the variant in which a plurality of groups of heating tubes 18, designed for different heating capacity, can be arranged in series or one above the other, as seen in the direction of the center axis M of the housing 2.

In the variant of the device 1 which is shown in FIG. 5, the discharge line 24 leads downwards in the vertical direction from the outflow chamber 16. This configuration of the discharge line 24, and the vertically downwards directed discharge of the heated steam which is associated therewith, can also be combined with a single-stage heating.

An advantageous embodiment of a steam turbine plant 62 is shown in FIG. 6. It comprises a live-steam generator 66, a high-pressure turbine 70 and a low-pressure turbine 74. The device 1 is connected on the flow side between the high-pressure turbine 70 and the low-pressure turbine 74. The live steam which is produced in the live-steam generator 66 is directed into the high-pressure turbine 70 for performing work. While performing work, the steam expands in the high-pressure turbine 70, as a result of which its water fraction increases. So that the steam in the low-pressure turbine 74 can be used as efficiently as possible for energy generation, it must be processed in a suitable manner. To this end, its water fraction must be reduced before it is subsequently converted into a superheated state. For this reason, the steam which issues from the steam outlet of the high-pressure turbine 70 is directed via a distributor through feed lines 6 into the housing 2 of the device 1. There, the steam flows in tangentially to the inner side 11 of the housing and is set in rotation as a result. The gaseous fraction of the steam flows into the interior of the housing where it is transferred into a superheated state by means of heating elements, especially heating tubes. From there, the superheated steam is directed through discharge lines 24 into the steam inlet of the low-pressure turbine 74. There, the steam which is processed in this way can be further used for energy generation. In this exemplary embodiment, the heating tubes (not drawn in in this case) of the device 1 are supplied with live steam from the live-steam generator 66 through the heating feed line 78. Alternatively or additionally, bleed steam could be extracted from the high-pressure turbine 70 for this purpose.

The device 1 is naturally not limited to use in steam turbine plants. It can essentially always be used where the heavier component or phase is to be separated from a multiphase fluid flow and the gaseous fraction is to be heated or superheated. The heavy component of the fluid flow in this case can be water, as explained above. However, applications in which the heavy component consists of solid particles are also conceivable. In this case, it could be soot or dirt particles, for example.

### List of Designations

1 Device
2 Housing
3 Cavity
6 Feed line
10 Inflow direction
11 Inner side of housing
12 Inflow chamber
14 Annulus
16 Outflow chamber
18 Heating tube
20 Individual bundle
22 Flow direction
24 Discharge line
28 Fine separator
32 Baffle plate
34 Perforated plate
36 Guide vane
37 Partitioning plate
38 Live-steam feed line
40 Bleed-steam feed line
42, 43 Condensate drain
46 Condensate drain line
50 Fine-separator condensate drain line
54 Inner boundary
58 Outer boundary
62 Steam turbine plant
66 Live-steam generator
70 High-pressure turbine
74 Low-pressure turbine
78 Heating feed line
82 Partitioning plate
M Center axis

1-19. (canceled)

20. A device for phase separation of a multiphase fluid flow, the device comprising:
a housing being rotationally symmetrically configured around a center axis and enclosing a cavity;
an annulus disposed concentrically around said center axis;
at least one feed line for the multiphase fluid flow, said feed line configured for an inflow of the multiphase fluid flow oriented tangentially to an inner side of said housing;
at least one discharge line for a separated gaseous fraction of the multiphase fluid flow; and
heating elements configured for heating the separated gaseous fraction and disposed in said cavity in said annulus.

21. The device according to claim 20, wherein said annulus with said heating elements is configured for a through flow of the separated gaseous fraction of the multiphase fluid flow and splits said cavity into an inflow chamber, which lies between said inner side of said housing and said annulus, and into an outflow chamber, which lies inside said annulus.

22. The device according to claim 20, wherein said housing is of a generally hollow cylindrical design.

23. The device according to claim 20, wherein said center axis has a substantially vertical orientation.

24. The device according to claim 20, wherein said heating elements, with regard to their heating capacity, are configured for superheating the separated gaseous fraction of the fluid flow, including steam.

25. The device according to claim 20, wherein said feed line is configured such that a velocity vector of the fluid flow entering said cavity has a component in a direction of the center axis of said housing.

26. The device according to claim 25, wherein said feed line is configured such that the velocity vector of the fluid flow entering said cavity is inclined by 10 to 30 degrees with regard to a plane which is perpendicular to said center axis.

27. The device according to claim 20, wherein said feed line is one of four feed lines which are disposed with a uniform distribution over said circumference of said housing.

28. The device according to claim 21, further comprising guide elements selected from the group consisting baffle plates and guide vanes, for guiding the separated gaseous fraction of the fluid flow into said annulus, said guide elements are disposed in said inflow chamber.

29. The device according to claim 21, further comprising:
fine separators disposed in said inflow chamber; and
a fine-separator condensate drain line inserted into said inflow chamber, by means of which condensate which forms in said fine separators in an operating state is drained from said cavity.

30. The device according to claim 20, wherein at least two groups of said heating elements are disposed in series in said annulus, as seen in a direction of said center axis, said heating elements are designed for different heating capacities in each case.

31. The device according to claim 20, wherein said heating elements are of a tubular design and are designed for being exposed to through flow by a fluid heating medium, especially steam.

32. The device according to claim 31, wherein said heating elements are rectilinear tubes in each case and are oriented parallel to said center axis.

33. The device according to claim 31, wherein a plurality of said heating elements, which are adjacent to each other, are combined to form a bundle.

34. The device according to claim 20, further comprising an annular partitioning plate, which is oriented perpendicularly to said center axis, is inserted into said housing, said annular partitioning plate splitting said cavity into two cavity sections, and an inner circle of which coincides essentially with an inner circle of said annulus, and an outer circle radius of which is smaller than a radius of said inner side of said housing.

35. The device according to claim 25, wherein said feed line is configured such that a velocity vector of the fluid flow entering said cavity is inclined by 15 degrees, with regard to a plane which is perpendicular to said center axis.

36. A steam turbine plant, comprising:
a high-pressure turbine having a steam outlet;
a low-pressure turbine having a steam inlet; and
a device for phase separation of a multiphase fluid flow, said device containing:
a housing being rotationally symmetrically configured around a center axis and enclosing a cavity;
an annulus disposed concentrically around said center axis;
at least one feed line for the multiphase fluid flow, said feed line configured for an inflow of the multiphase fluid flow oriented tangentially to an inner side of said housing;
at least one discharge line for a separated gaseous fraction of the multiphase fluid flow;
heating elements configured for heating the separated gaseous fraction and disposed in said cavity in said annulus;
said feed line connected to said steam outlet of said high-pressure turbine; and
said at least one discharge line connected to said steam inlet of said low-pressure turbine.

37. A method for operating a steam turbine plant with a high-pressure turbine and a low-pressure turbine, which comprises the steps of:
directing steam extracted from a steam outlet of the high-pressure turbine into a cavity enclosed by a housing which is rotationally symmetrical around a center axis, as a result of which the steam is set in rotation and its gaseous fraction is separated from a liquid fraction and collected in an inner region of the housing;
heating the gaseous fraction during its transfer into the inner region by means of heating elements; and
feeding the gaseous fraction to a steam inlet of the low-pressure turbine.

38. The method according to claim 37, wherein at least some of the heating elements are of a tubular design and are exposed to through flow by live steam which is produced in a steam generator.

39. The method according to claim 37, wherein at least some of the heating elements are of a tubular design, and wherein bleed steam is extracted from the high-pressure turbine and directed into the heating elements.
